(19) United States
(12) Patent Application Publication
(10) Pub. No.: US 2025/0284534 A1
(43) Pub. Date: Sep. 11, 2025

(54) Smart Scheduling System and Method for Performing Smart Scheduling using Linear Programming

(71) Applicant: United Semiconductor (Xiamen) Co., Ltd., Xiamen (CN)

(72) Inventors: QI ZUO, Shamen City (CN); YOU SHENG YIN, Shamen City (CN); WEN YI TAN, Xiamen (CN)

(73) Assignee: United Semiconductor (Xiamen) Co., Ltd., Xiamen (CN)

(21) Appl. No.: 18/624,050

(22) Filed: Apr. 1, 2024

(30) Foreign Application Priority Data
Mar. 8, 2024 (CN) 202410268898.4

(51) Int. Cl. G06F 9/48; G06Q 50/04

(52) U.S. Cl. CPC G06F 9/4881; G06Q 50/04

(57) ABSTRACT

A smart scheduling system includes a user interface, a real-time dispatching system, an active manager analysis system, a scheduling system, and an activity manager. The user interface is used to set parameters of a plurality of machines. The real-time dispatching system is used to retrieve a plurality of basic data of the plurality of machines and a plurality of materials. The active manager analysis system is used to determine schedules of the machines and testing machines of the plurality of machines based on the plurality of basic data. The scheduling system is used to assign the testing machines to perform testing. The activity manager is used to assign the machines to produce the materials according to the schedules of the machines.

### BACKGROUND OF THE INVENTION

### 1. Field of the Invention

The present invention relates to a smart scheduling system and a method for performing smart scheduling, in particularly a smart scheduling system and a method for performing smart scheduling using linear programming.

### 2. Description of the Prior Art

Monitoring of none product wafers (NPWs) is performed before using the machine to produce products. None product wafers are used to assess whether the performance of the machine aligns with production standards. Common monitoring scenarios encompass machine crashes, maintenance activities, replacement of production chemicals, and testing of machine parameters and environmental conditions following continuous production over a specific time duration.

Currently, the testing system prepares monitoring materials regularly and quantitatively based on the process setting time. Online operators then decide whether to test the machine based on the materials waiting in process (WIP), machine condition, and the remaining testing time, etc.

In the current testing process, the combination of regular and quantitative testing relies on online human judgment, leading to inefficiencies in human resources. Furthermore, variations in the experiences and individual judgments of online personnel may result in situations where tests should be conducted but are not, posing risks to production quality. Conversely, there is also a possibility of testing the machine when it should not be tested, leading to wastage of testing resources and machine production capacity.

### SUMMARY OF THE INVENTION

An embodiment discloses a smart scheduling system. The smart scheduling system comprises a user interface, a real-time dispatching system, an active manager analysis system, a scheduling system, and an activity manager. The user interface is used to set parameters of a plurality of machines. The real-time dispatching system is used to retrieve a plurality of basic data of the plurality of machines and a plurality of materials. The active manager analysis system is used to determine schedules of the machines and testing machines of the plurality of machines based on the plurality of basic data. The scheduling system is used to assign the testing machines to perform testing. The activity manager is used to assign the machines to produce the materials according to the schedules of the machines.

Another embodiment discloses a method for performing smart scheduling. The method comprises setting parameters for a plurality of machines, retrieving a plurality of basic data of the plurality of machines and a plurality of materials, determining schedules of the machines and testing machines of the plurality of machines based on the plurality of basic data, assigning the testing machines to perform testing, and assigning the machines to produce the materials according to the schedules of the machines.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of the smart scheduling system according to an embodiment of the present invention.

FIG. 2 is a flow chart of the operation method of the smart scheduling to an embodiment of the present invention.

### DETAILED DESCRIPTION

Before producing materials and testing machines, the smart scheduling system can appropriately allocate the quantity of materials to be produced by each machine and the machines to be tested. The basis for allocation is to initialize the data and obtain the best solution through linear programming. The data that can be initialized includes the production allocation of each material on each machine, and whether each machine requires machine testing before production.

TABLE 1
Material production distribution table on the machines

| | Quantity | Machine 1 | Machine 2 | Machine 3 |
|---|---|---|---|---|
| Material 1 | 100 | X11 | X12 | X13 |
| Material 2 | 150 | X21 | X22 | X23 |
| Material 3 | 200 | X31 | X32 | X33 |

As shown in Table 1, set the quantity of material 1 to be produced by machine 1 as X11, the quantity of material 1 to be produced by machine 2 as X12, and the quantity of material 1 to be produced by machine 3 as X13. Then, set the quantity of material 2 to be produced by machine 1 as X21, the quantity of material 2 to be produced by machine 2 as X22, and the quantity of material 2 to be produced by machine 3 as X23. At last, set the quantity of material 3 to be produced by machine 1 as X31, the quantity of material 3 to be produced by machine 2 as X32, and the quantity of material 3 to be produced by machine 3 as X33. Since the total quantity of material is fixed, the following equation can be written to limit the initialization values:

$$\begin{matrix}X 11 + X 12 + X 13 = 100 \\ X 21 + X 22 + X 23 = 150 \\ X 31 + X 32 + X 33 = 200\end{matrix}$$

The three equations are used to limit the production quantity of materials allocated to each machine. If the full production capacity of each machine is set to move per day (MPD), the operating production load of each machine can be expressed by the following equation:

$$\begin{matrix}E 1 = ( X 11 + X 21 + X 31 ) / MPD \\ E 2 = ( X 12 + X 22 + X 32 ) / MPD \\ E 3 = ( X 13 + X 23 + X 33 ) / MPD \\ E min \leq E 1 \leq E max \\ E min \leq E 2 \leq E max \\ E min \leq E 3 \leq E max\end{matrix}$$

Where E1, E2, and E3 represent the operating production loads of machine 1, machine 2, and machine 3, respectively, and Emax and Emin represent the maximum and minimum production loads of the machines. The larger Emax-Emin is, the more uneven the load distribution is, so the objective function is to find the minimum value of Emax-Emin. However, the test machine has not been considered in the equation here. The constraints of machine production are listed in Table 2:

TABLE 2
Material production restriction status table on the machines

| | Quantity | Machine 1 | Machine 2 | Machine 3 |
|---|---|---|---|---|
| Material 1 | 100 | 1 (need test) | 1 | 0 |
| Material 2 | 150 | 1 | 0 | 1 |
| Material 3 | 200 | 0 | 1 (need test) | 1 |

As shown in Table 2, 1 in the table corresponds to a machine that can produce the material, while 0 corresponds to a machine that cannot produce the material. In Table 2, material 1 can be produced by machine 1 and machine 2, material 2 can be produced by machine 1 and machine 3, and material 3 can be produced by machine 2 and machine 3. Before machine 1 produces material 1, machine 1 needs to tested first, and before machine 2 produces material 3, machine 2 needs to tested first. If Mij is set according to whether machine j should be tested before producing material i, Mij is 1 if machine j should be tested before producing material i, and Mij is 0 if machine j need not be tested before producing material i. The following inequalities can be listed to determine whether the machines should be tested:

$$\begin{matrix}\frac{X 11 M 11 + X 21 M 21 + X 31 M 31}{X 11 + X 21 + X 31} \leq Monitor EQ 1 \\ \frac{X 12 M 12 + X 22 M 22 + X 32 M 32}{X 12 + X 22 + X 32} \leq Monitor EQ 2 \\ \frac{X 13 M 13 + X 23 M 23 + X 33 M 33}{X 13 + X 23 + X 33} \leq Monitor EQ 3 \\ Count = Monitor EQ 1 + Monitor EQ 2 + Monitor EQ 3\end{matrix}$$

In the above three inequalities, a non-zero left side implies that the machine needs to be tested, and Monitor EQ1, Monitor EQ2, and Monitor EQ3 represent whether machine 1, machine 2, and machine 3 should be tested respectively. If machine 1 needs to be tested, then Monitor EQ1 is 1, if machine 1 need not be tested, Monitor EQ1 is 0. If machine 2 needs to be tested, then Monitor EQ2 is 1, if machine 2 need not be tested, Monitor EQ2 is 0. If machine 3 needs to be tested, then Monitor EQ3 is 1, if machine 3 need not be tested, Monitor EQ3 is 0. Count is the total number of machines that need to be tested. Combining all of the above equation, inequalities and initialization conditions, the objective expression can be set as follows:

$$min ( E max - E min + Count ) .$$

In order to minimize this expression, an appropriate material allocation table can be calculated through linear programming, where X11=0, X12=100, X13=0, X21=150, X22=0, X23=0, X31=0, X32=50, X33=150, summarized in Table 3:

TABLE 3
Material production distribution of the machines

| | Quantity | Machine 1 | Machine 2 | Machine 3 |
|---|---|---|---|---|
| Material 1 | 100 | 0 | 100 | 0 |
| Material 2 | 150 | 150 | 0 | 0 |
| Material 3 | 200 | 0 | 50 | 150 |

In Table 3, machine 1 produces 150 units of material 2. Machine 2 produces 100 units of material 1, and produces 50 units of material 3. Machine 3 produces 150 units of material 3. In this distribution, the production quantity of each machine is 150 units, which is the optimal distribution because three machines produce the same number of units of materials. Since machine 2 needs to produce material 3, machine 2 needs to be tested before producing material 3. Machine 1 and machine 3 need not be tested.

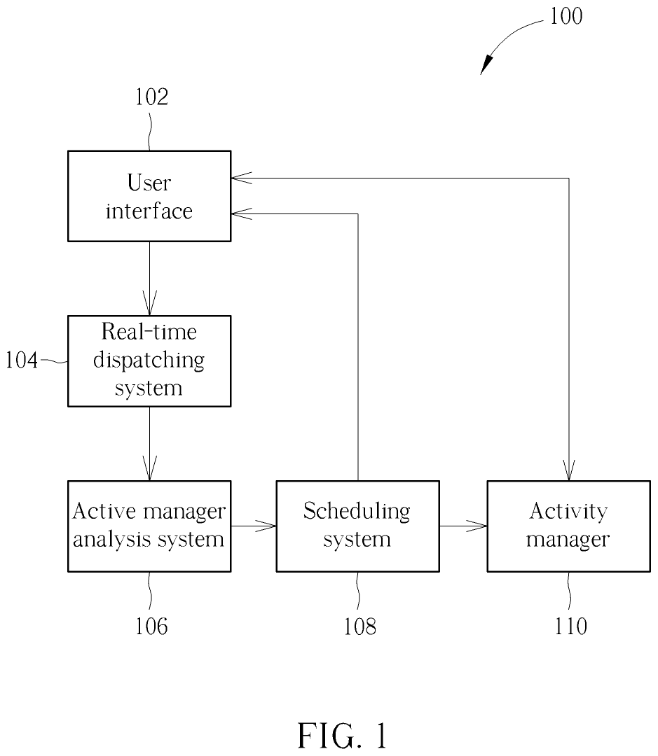

FIG. 1 is a block diagram of the smart scheduling system 100 according to an embodiment of the present invention. The smart scheduling system 100 includes a user interface 102, a real-time dispatching system 104, an active manager analysis system 106, a scheduling system 108 and an activity manager 110. The user interface 102 is linked to the real-time dispatching system 104, the scheduling system 108 and the activity manager 110, and is used to set parameters of a plurality of machines. The real-time dispatching system 104 is linked to the user interface 102 and the active manager analysis system 106 to capture a plurality of basic data of the machines and a plurality of materials. The active manager analysis system 106 is linked to the real-time dispatching system 104 and the scheduling system 108 to determine the schedules of the machines and the test machines among the machines based on the basic data. The scheduling system 108 is linked to the active manager analysis system 106, the user interface 102 and the activity manager 110 to assign the test machines to perform testing. The activity manager 110 is linked to the scheduling system 108 and the user interface 102, and is used to assign the machines to produce the materials according to the schedules of the machines. The active manager analysis system 106 can perform linear programming based on the initialized data to determine the schedules of the machines and the test machines among the machines, thereby effectively implementing scheduling of the smart scheduling system 100.

In an embodiment, the user interface 102 sets the parameters of the machines based on none product wafers (NPW). The basic data in the real-time dispatching system 104 include quantity of the materials, materials disallowed to be produced by the machines, and a full production capacity of each machine. In another embodiment, the scheduling system 108 returns the assigned testing machines to the user interface 102. The activity manager 110 returns the schedules assigned to the machines to produce the materials to the user interface 102.

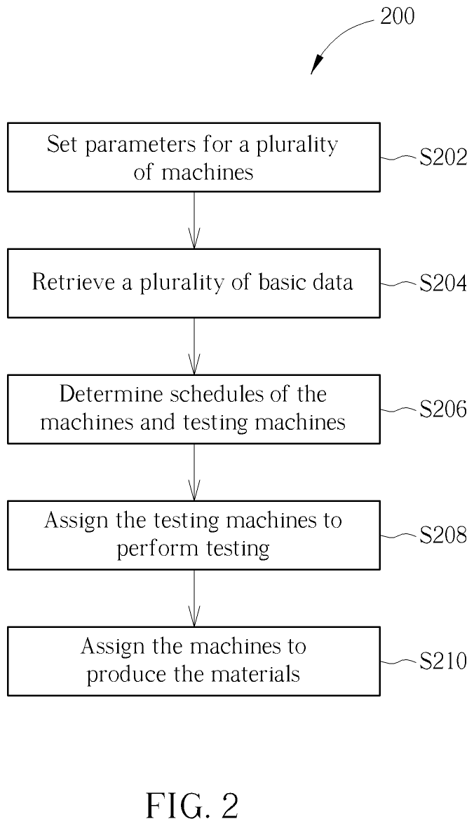

FIG. 2 is a flow chart of the operation method 200 of the smart scheduling system 100 according to an embodiment of the present invention. The operation method 200 includes the following steps:
Step S202: Set parameters for a plurality of machines;
Step S204: Retrieve a plurality of basic data;
Step S206: Determine schedules of the machines and testing machines;
Step S208: Assign the testing machines to perform testing; and
Step S210: Assign the machines to produce the materials.

In step S202, the user interface 102 sets parameters of a plurality of machines based on none product wafers (NPWs). In step S204, the real-time dispatching system 104 retrieves a plurality of basic data of the machines and a plurality of materials. The basic data include quantity of the materials, materials disallowed to be produced by the machines, information of each machine, and a full production capacity of each machine. In step S206, the active manager analysis system 106 determines the schedules of the machines and the test machines among the machines based on the basic data. The active manager analysis system 106 determines the schedules of the machines and the test machines among the machines based on the results of linear programming. In step S208, the scheduling system 108 assigns the testing machine to perform testing. In step S210, the activity manager 110 assigns the machines to produce the materials according to the schedules of the machines.

In conclusion, according to the smart scheduling system 100 and its operation method 200, the most suitable machine scheduling and testing machine can be found through linear programming, and no human resources are consumed. Compared with the prior art, the present invention can test machines and produce materials in time, thus reducing the number of testing machines and optimizing the schedules of all machines. The present invention avoids a waste of testing machine resources and a waste of machine production capacity due to not testing machines when they should be tested and testing machines when there is no need to test.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A smart scheduling system, comprising:
a user interface, configured to set parameters of a plurality of machines;
a real-time dispatching system, configured to retrieve plurality of basic data of the plurality of machines and a plurality of materials;
an active manager analysis system, configured to determine schedules of the machines and testing machines of the plurality of machines based on the plurality of basic data;
a scheduling system, configured to assign the testing machines to perform testing; and
an activity manager, configured to assign the machines to produce the materials according to the schedules of the machines.

2. The smart scheduling system of claim 1, wherein the user interface sets the parameters of the plurality of machines according to none product wafers (NPW).

3. The smart scheduling system of claim 1, wherein the plurality of basic data comprise quantity of the materials, materials disallowed to be produced by the machines, and a full production capacity of each machine.

4. The smart scheduling system of claim 1, wherein the active manager analysis system performs linear programming on the plurality of basic data to determine the schedules of the machines and the testing machines of the plurality of machines.

5. The smart scheduling system of claim 1, wherein the scheduling system returns the testing machines to the user interface.

6. The smart scheduling system of claim 1, wherein the activity manager returns the schedules of the machines to the user interface.

7. A method for performing smart scheduling, comprising:
setting parameters for a plurality of machines;
retrieving a plurality of basic data of the plurality of machines and a plurality of materials;
determining schedules of the machines and testing machines of the plurality of machines based on the plurality of basic data;
assigning the testing machines to perform testing; and
assigning the machines to produce the materials according to the schedules of the machines.

8. The method of claim 7, wherein setting the parameters for the plurality of machines is setting the parameters for the plurality of machines according to none product wafers (NPW).

9. The method of claim 7, wherein the plurality of basic data comprise quantity of the materials, materials disallowed to be produced by the machines, and a full production capacity of each machine.

10. The method of claim 7, wherein determining the schedules of the machines and the testing machines of the plurality of machines based on the plurality of basic data is performing linear programming on the plurality of basic data to determine the schedules of the machines and the testing machines of the plurality of machines.
